(19) United States
(12) Patent Application Publication
(10) Pub. No.: US 2021/0066708 A1
(43) Pub. Date: Mar. 4, 2021

(54) COMPOSITIONS CONTAINING CARBON BLACK AND GRAPHENES ADDITIVES, RELATED ELECTRODES AND RELATED BATTERIES

(71) Applicant: Cabot Corporation, Boston, MA (US)

(72) Inventors: Aurelien DuPasquier, Westford, MA (US); Deanna Lanigan, Pittsburg, PA (US); Persefoni Kechagia, Lexington, MA (US)

(21) Appl. No.: 17/007,356

(22) Filed: Aug. 31, 2020

Related U.S. Application Data
(60) Provisional application No. 62/907,892, filed on Sep. 30, 2019.

(51) Int. Cl. H01M 4/133; H01M 4/525; C09C 1/48; C01B 32/182

(52) U.S. Cl. CPC H01M 4/133; H01M 4/525; C09C 1/48; C01B 32/182; C01P 2002/70; C01P 2006/12; C01B 2204/22; C01P 2004/51; C01P 2006/40; C01P 2006/19

(57) ABSTRACT

An electrode includes an electrode composition having graphenes; carbon black particles having a Brunauer-Emmett-Teller (BET) surface area greater than 90 m²/g, and an oil adsorption number (OAN) greater than 150 mL/100 g, wherein the ratio of the carbon black particles to the graphenes ranges from 3:1 to 6:1 by weight; and an electroactive material selected from the group consisting of lithium nickel cobalt manganese oxide and lithium nickel cobalt aluminum oxide, wherein the total concentration of the graphenes and the carbon black particles is equal to or less than 2 wt % of the electrode composition; and a current collector contacting the electrode composition.

### FIELD OF THE INVENTION

The invention relates to compositions containing carbon black and graphenes additives, related electrodes, and related batteries.

### BACKGROUND

Lithium-ion batteries are commonly used sources of electrical energy for a variety of applications, such as electronic devices and electric vehicles. A lithium-ion battery typically includes a negative electrode (e.g., graphite) and a positive electrode (described below) that allow lithium ions and electrons to move to and from the electrodes during charging and discharging. An electrolyte solution in contact with the electrodes provides a conductive medium in which the ions can move. To prevent direct reaction between the electrodes, an ion-permeable separator is used to physically and electrically isolate the electrodes. When the battery is used as an energy source for a device, electrical contact is made to the electrodes, allowing electrons to flow through the device to provide electrical power, and lithium ions to move through the electrolyte from one electrode to the other electrode.

The positive electrode typically includes a conductive substrate supporting a mixture (e.g., applied as a paste) having at least an electroactive material, a binder, and a conductive additive. The electroactive material, such as a lithium transition metal oxide, is capable of receiving and releasing lithium ions. The binder, such as polyvinylidene fluoride, is used to provide mechanical integrity and stability to the electrode. Typically, since the electroactive material and the binder are electrically poorly conducting or insulating, the conductive additive (e.g., graphite and carbon black) is added to enhance the electrical conductivity of the electrode. The conductive additive and the binder, however, are generally not involved in electrochemical reactions that generate electrical energy, so these materials can negatively affect certain performance characteristics (e.g., capacity and energy density) of the battery since they effectively lower the amount of electroactive material that can be contained in the positive electrode.

### SUMMARY

In one aspect, the invention features electrodes, electrode compositions, compositions (e.g., slurries, pastes) that can be used to make electrodes, batteries, and related methods having a combination of carbon black particles and graphenes as conductive carbon additives (CCAs).

Applicant has discovered that using a combination of conductive additives, namely, certain carbon black particles and graphenes, in certain ratios, can enhance the performance of batteries containing certain electroactive materials, namely, lithium nickel cobalt manganese oxide (“NCM”) and lithium nickel cobalt aluminum oxide (“NCA”). For example, compared to batteries containing only carbon nanotubes as the conductive additive, the combination of carbon black particles and graphenes can still provide good electrode conductivity, charge and discharge rate capability and improved low-temperature capacity at reduced costs and impurities (e.g., trace cobalt or iron used to produce carbon nanotubes that can be detrimental to battery performance). Without being bound by theory, it is believed that the carbon black particles and the graphenes form a three-dimensional conductive network that covers and bridges particles of the electroactive material, thereby providing short-range conductivity (via the carbon black) among the particles of the electroactive material, and long-range conductivity (via the graphenes) between the particles of the electroactive material and the current collector. However, having too much graphenes (e.g., enough to coat particles of the electroactive material) can be detrimental to battery performance since the graphenes can block ionic transport to the electroactive material. Carbon black, on the other hand, can coat the electroactive material since the microporosity of the carbon black allows electrolyte access or ionic transport to the electroactive material.

In another aspect, the invention features an electrode, including an electrode composition having graphenes; carbon black particles having a Brunauer-Emmett-Teller (BET) surface area greater than 90 m²/g, and an oil adsorption number (OAN) greater than 150 mL/100 g, wherein the ratio of the carbon black particles to the graphenes ranges from 3:1 to 6:1 by weight; and an electroactive material selected from the group consisting of lithium nickel cobalt manganese oxide and lithium nickel cobalt aluminum oxide, wherein the total concentration of the graphenes and the carbon black particles is equal to or less than 2 wt % of the electrode composition; and a current collector contacting the electrode composition.

In another aspect, the invention features a composition, including: graphenes; carbon black particles having a Brunauer-Emmett-Teller (BET) surface area greater than 90 m²/g, and an oil adsorption number (OAN) greater than 150 mL/100 g, wherein the ratio of the carbon black particles to the graphenes ranges from 3:1 to 6:1 by weight; and a liquid medium.

In another aspect, the invention features batteries including electrodes as described and/or claimed herein.

In another aspect, the invention features a method comprising: using the composition as described and/or claimed herein to make an electrode or a battery.

Embodiments of the aspects of the invention may include one or more of the following features. The total concentration of the graphenes and the carbon black particles ranges from 0.1 to 2 wt % of the electrode composition. The ratio of the carbon black particles to the graphenes ranges from 3.5:1 to 4.5:1 by weight. The electrode includes from 95 to 99 wt % of the electroactive material. The electroactive material includes lithium nickel cobalt manganese oxide. The carbon black particles have a BET surface area less than 400 m²/g. The carbon black particles have an OAN less than 250 mL/100 g. The carbon black particles have a surface energy less than 5 mJ/m². The carbon black particles have an Lₐ crystallite size, as determined by Raman spectroscopy, ranging from 50 Å to 100 Å. The carbon black particles have an L_{c} crystallite size, as determined by X-ray diffraction, ranging from 50 Å to 100 Å. The carbon black particles have a % crystallinity ((I_{G}/(I_{G}+I_{D}))×100%), as determined by Raman spectroscopy, ranging from 35% to 70%. The carbon black particles have an aggregate size distribution, as indicated by D₅₀ values of particle size distributions, ranging from 20 to 400 nm.

The carbon black particles have one, two, three, four, five, six, or seven of the following properties, in any combination: a surface energy less than 5 mJ/m²; an Lₐ crystallite size, as determined by Raman spectroscopy, greater than 50 Å; an L_{c} crystallite size, as determined by X-ray diffraction, greater than 50 Å; % crystallinity ((I_{G}/(I_{G}+I_{D}))×100%), as determined by Raman spectroscopy, greater than 35%; an STSA greater than 50 m²/g; an aggregate size distribution, as indicated by D₅₀ values of particle size distributions, greater than 20 nm; and/or an oxygen content from 0 to 0.1 wt %.

The carbon black particles have one, two, three, four, five, or six of the following properties, in any combination: an Lₐ crystallite size, as determined by Raman spectroscopy, less than 100 Å; an L_{c} crystallite size, as determined by X-ray diffraction, less than 100 Å; % crystallinity ((I_{G}/(I_{G}+I_{D}))×100%), as determined by Raman spectroscopy, less than 70%; an STSA less than 250 m²/g; an aggregate size distribution, as indicated by D₅₀ values of particle size distributions, less than 400 nm; and/or an oxygen content from 0 to 0.1 wt %.

The carbon black particles have one, two, three, four, five, or six of the following properties, in any combination: an Lₐ crystallite size, as determined by Raman spectroscopy, ranging from 50 Å to 100 Å; an L_{c} crystallite size, as determined by X-ray diffraction, ranging from 50 Å to 100 Å; a % crystallinity ((I_{G}/(I_{G}+I_{D}))×100%), as determined by Raman spectroscopy, ranging from 35% to 70%; an STSA ranging from 50 to 250 m²/g; an aggregate size distribution, as indicated by D₅₀ values of particle size distributions, ranging from 20 to 400 nm; and/or oxygen content from 0 to 0.1 wt %.

The graphenes have one or both of the following properties: a BET surface area greater than 100 m²/g; and/or less than or equal to about 20 graphitic layers. The graphenes have one or both of the following properties: a BET surface area less than 500 m²/g; and/or more than or equal to about 5 graphitic layers. The graphenes have one or both of the following properties: a BET surface area ranging from 100 to 500 m²/g; and/or from about 20 to about 5 graphitic layers.

The liquid medium is selected from the group consisting of N-methylpyrrolidone (NMP), acetone, an alcohol, and water. The composition further includes a dispersant.

The method includes combining lithium nickel cobalt manganese oxide or lithium nickel cobalt aluminum oxide with the compositions described and/or claimed herein. The method includes combining lithium nickel cobalt manganese oxide with the compositions described and/or claimed herein.

Unless expressly indicated otherwise, all percentages herein are weight percentages.

Other aspects, features, and advantages of the invention will be apparent from the description of the embodiments thereof and from the claims.

### BRIEF DESCRIPTION OF THE DRAWINGS

FIG. 1 is a plot showing through-plane conductivity vs. conductive carbon additive (“CCA”) blend formulation of 30 mg/cm²Li₁₊ₓ(Ni_{0.6}Co_{0.2}Mn_{0.2})₁₋ₓO₂ (“NCM622”) cathodes calendered at 3.5 g/cc.

FIG. 2 is a plot showing 2D discharge capacity vs. CCA blend formulation of 25 or 30 mg/cm² NCM622 cathodes calendered at 3.5 g/cc.

FIG. 3 is a plot showing 2C charge capacity vs. CCA blend formulation of 25 or 30 mg/cm² NCM622 cathodes calendered at 3.5 g/cc.

FIG. 4 is a plot showing C/2 dicharge capacity vs. charging rate for CCA blend formulations #1, 3, and 4 in 30 mg/cm² NCM622 cathodes calendered at 3.5 g/cc.

FIG. 5 is a plot showing DC internal resistance (DC-IR) at 20, 50 and 80% state of charge (“SOC”) vs. CCA blend formulation of 25 or 30 mg/cm² NCM622 cathodes calendered at 3.5 g/cc.

### DETAILED DESCRIPTION OF THE EMBODIMENTS

Described herein are compositions (e.g., slurries) that can be used to produce electrodes for batteries (e.g., lithium ion batteries), methods of making the compositions, and applications of the compositions in electrodes (e.g., cathodes) and batteries.

The compositions typically include a combination of carbon black particles and graphenes and a liquid medium (e.g., N-methylpyrrolidone (NMP)). The compositions can be combined with lithium nickel cobalt manganese oxide (“NCM”) or lithium nickel cobalt aluminum oxide (“NCA”), with or without a binder (e.g., poly(vinyldifluoroethylene) (PVDF)), to form an electrode composition that can be applied to a current collector to form an electrode, which can be used to produce a battery.

In certain embodiments, the carbon black particles are characterized by their surface areas and oil adsorption numbers (i.e., structure). The carbon black particles can have a relatively wide range of total surface areas. Without being bound by theory, it is believed that, during use of a battery, there are chemical side reactions that can occur within the battery that degrade its performance. Having particles with lower surface areas can enhance the performance of the battery by providing fewer surface sites where these unwanted side reactions can occur. However, the surface areas of the particles should be balanced, i.e., high enough, so that the particles can sufficiently cover and/or bridge the NCM or NCA and provide the desired electrode conductivity. In some embodiments, the carbon black particles have a Brunauer-Emmett-Teller (BET) surface area greater than or equal to 90 m²/g, or less than or equal to 400 m²/g, for example, ranging from 90 to 400 m²/g. The BET surface area can have or include, for example, one of the following ranges: from 90 to 375 m²/g, or from 90 to 350 m²/g, or from 90 to 325 m²/g, or from 90 to 300 m²/g, or from 90 to 275 m²/g, or from 90 to 250 m²/g, or from 90 to 225 m²/g, or from 90 to 200 m²/g, or from 90 to 175 m²/g, or from 90 to 150 m²/g, or from 90 to 125 m²/g, or from 125 to 400 m²/g, or from 125 to 375 m²/g, or from 125 to 350 m²/g, or from 125 to 325 m²/g, or from 125 to 300 m²/g, or from 125 to 275 m²/g, or from 125 to 250 m²/g, or from 125 to 225 m²/g, or from 125 to 200 m²/g, or from 125 to 175 m²/g, or from 125 to 150 m²/g, or from 150 to 400 m²/g, or from 150 to 375 m²/g, or from 150 to 350 m²/g, or from 150 to 325 m²/g, or from 150 to 300 m²/g, or from 150 to 275 m²/g, or from 150 to 250 m²/g, or from 150 to 225 m²/g, or from 150 to 200 m²/g, or from 150 to 175 m²/g, or from 175 to 400 m²/g, or from 175 to 375 m²/g, or from 175 to 350 m²/g, or from 175 to 325 m²/g, or from 175 to 300 m²/g, or from 175 to 275 m²/g, or from 175 to 250 m²/g, or from 175 to 225 m²/g, or from 175 to 200 m²/g, or from 200 to 400 m²/g, or from 200 to 375 m²/g, or from 200 to 350 m²/g, or from 200 to 325 m²/g, or from 200 to 300 m²/g, or from 200 to 275 m²/g, or from 200 to 250 m²/g, or from 200 to 225 m²/g, or from 225 to 400 m²/g, or from 225 to 375 m²/g, or from 225 to 350 m²/g, or from 225 to 325 m²/g, or from 225 to 300 m²/g, or from 225 to 275 m²/g, or from 225 to 250 m²/g, or from 250 to 400 m²/g, or from 250 to 375 m²/g, or from 250 to 350 m²/g, or from 250 to 325 m²/g, or from 250 to 300 m²/g, or from 250 to 275 m²/g, or from 275 to 400 m²/g, or from 275 to 375 m²/g, or from 275 to 350 m²/g, or from 275 to 325 m²/g, or from 275 to 300 m²/g, or from 300 to 400 m²/g, or from 300 to 375 m²/g, or from 300 to 350 m²/g, or from 300 to 325 m²/g, or from 325 to 400 m²/g, or from 325 to 375 m²/g, or from 325 to 350 m²/g, or from 350 to 400 m²/g, or from 350 to 375 m²/g, or from 375 to 400 m²/g. The BET surface area can have or include, for example, one of the following ranges: greater than or equal to 100 m²/g, or greater than or equal to 125 m²/g, or greater than or equal to 150 m²/g, or greater than or equal to 175 m²/g, or greater than or equal to 200 m²/g, or greater than or equal to 225 m²/g, or greater than or equal to 250 m²/g, or greater than or equal to 275 m²/g, or greater than or equal to 300 m²/g, or greater than or equal to 325 m²/g, or greater than or equal to 350 m²/g, or greater than or equal to 375 m²/g, or less than or equal to 375 m²/g, or less than or equal to 350 m²/g, or less than or equal to 325 m²/g, or less than or equal to 300 m²/g, or less than or equal to 275 m²/g, or less than or equal to 250 m²/g, or less than or equal to 225 m²/g, or less than or equal to 200 m²/g, or less than or equal to 175 m²/g, or less than or equal to 150 m²/g, or less than or equal to 125 m²/g, or less than or equal to 100 m²/g. Other ranges within these ranges are possible. All BET surface area values disclosed herein refer to BET nitrogen surface area and are determined by ASTM D6556-10, the entirety of which is incorporated herein by reference.

As with the BET surface areas, the carbon black particles can have a range of statistical thickness surface areas (STSAs), with the difference, if any, between BET surface area and STSA being indicative of the porosity of the particles. In some embodiments, the carbon black particles have STSAs greater than or equal to 50 m²/g, or less than or equal to 200 m²/g, for example, ranging from 50 to 200 m²/g. The STSAs can have or include, for example, one of the following ranges: from 50 to 175 m²/g, or from 50 to 150 m²/g, or from 50 to 125 m²/g, or from 50 to 100 m²/g, or from 50 to 75 m²/g, or from 75 to 200 m²/g, or from 75 to 175 m²/g, or from 75 to 150 m²/g, or from 75 to 125 m²/g, or from 75 to 100 m²/g, or from 100 to 200 m²/g, or from 100 to 175 m²/g, or from 100 to 150 m²/g, or from 100 to 125 m²/g, or from 125 to 200 m²/g, or from 125 to 175 m²/g, or from 125 to 150 m²/g, or from 150 to 200 m²/g, or from 150 to 175 m²/g, or from 175 to 200 m²/g. The STSAs can have or include, for example, one of the following ranges: greater than or equal to 75 m²/g, or greater than or equal to 100 m²/g, or greater than or equal to 125 m²/g, or greater than or equal to 150 m²/g, or greater than or equal to 175 m²/g, or less than or equal to 175 m²/g, or less than or equal to 150 m²/g, or less than or equal to 125 m²/g, or less than or equal to 100 m²/g, or less than or equal to 75 m²/g. Other ranges within these ranges are possible. Statistical thickness surface area is determined by ASTM D6556-10 to the extent that such determination is reasonably possible since in some cases heat treatment of some carbon black particles (described below) can affect the ability to determine STSA.

As with the BET surface areas and STSAs, the carbon black particles can have a range of oil absorption numbers (OANs), which are indicative of the particles' structures, or volume-occupying properties. For a given mass, high structure carbon black particles can occupy more volume than other carbon black particles having lower structures. When used as a conductive additive in a battery electrode, carbon black particles having relatively high OANs can provide a continuously electrically-conductive network (i.e., percolate) throughout the electrode at relatively lower loadings. Consequently, more NCM or NCA material can be used, thereby improving the performance of the battery. In some embodiments, the carbon black particles have OANs greater than or equal to 150 mL/100 g, or less than or equal to 250 mL/100 g, for example, ranging from 150 to 250 mL/100 g. The OANs can have or include, for example, one of the following ranges: from 150 to 230 mL/100 g, or from 150 to 210 mL/100 g, or from 150 to 190 mL/100 g, or from 150 to 170 mL/100 g, or from 170 to 250 mL/100 g, or from 170 to 230 mL/100 g, or from 170 to 210 mL/100 g, or from 170 to 190 mL/100 g, or from 190 to 250 mL/100 g, or from 190 to 230 mL/100 g, or from 190 to 210 mL/100 g, or from 210 to 250 mL/100 g, or from 210 to 230 mL/100 g, or from 230 to 250 mL/100 g. The OAN can have or include, for example, one of the following ranges: greater than or equal to 170 mL/100 g, or greater than or equal to 190 mL/100 g, or greater than or equal to 210 mL/100 g, or greater than or equal to 230 mL/100 g, or less than or equal to 230 mL/100 g, or less than or equal to 210 mL/100 g, or less than or equal to 190 mL/100 g, or less than or equal to 170 mL/100 g. Other ranges within these ranges are possible. All OAN values cited herein are determined by the method described in ASTM D 2414-16.

In addition to having the BET surface areas, STSAs, and OANs described herein, the carbon black particles can further have one or more (e.g., two, three, four, five, or six) of the following properties described herein, in any combination, including a surface energy as described herein, an Lₐ crystallite size as described herein; an L_{c} crystallite size as described herein; a % crystallinity as described herein; an aggregate size distribution as described herein; and/or an oxygen content as described herein.

In some embodiments, the carbon black particles are generally highly graphitized carbon black particles, as indicated by their low surface energies, among other things. Lower surface energy values are indicative of higher degrees of graphitization and can be associated with lower amounts of residual impurities on the surface of carbon black particles, and thus, their hydrophobicity. Without being bound by theory, it is believed that, up to a threshold purity level, purer particles can provide improved electrical conductivity and reduced likelihood of side reactions, thereby improving the performance of the particles. Surface energy can be measured by Dynamic Vapor (Water) Sorption (DVS) or water spreading pressure (described below). In some embodiments, the carbon black particles have a surface energy (SE or SEP) less than or equal to 5 mJ/m², e.g., from the detection limit (about 2 mJ/m²) to 5 mJ/m². The surface energy can have or include, for example, one of the following ranges: from the detection limit to 4 mJ/m², or from the detection limit to 3 mJ/m². In certain embodiments, the surface energy, as measured by DWS, is less than or equal to 4 mJ/m², or less than or equal to 3 mJ/m². Other ranges within these ranges are possible.

Water spreading pressure is a measure of the interaction energy between the surface of carbon black (which absorbs no water) and water vapor. The spreading pressure is measured by observing the mass increase of a sample as it adsorbs water from a controlled atmosphere. In the test, the relative humidity (RH) of the atmosphere around the sample is increased from 0% (pure nitrogen) to about 100% (water-saturated nitrogen). If the sample and atmosphere are always in equilibrium, the water spreading pressure (π_{c}) of the sample is defined as:

$${π}_{e} = \frac{RT}{A} {\int }_{o}^{{P}_{o}} Γ dlnP$$

where R is the gas constant, T is the temperature, A is the BET surface area of the sample as described herein, Γ is the amount of adsorbed water on the sample (converted to moles/gm), P is the partial pressure of water in the atmosphere, and P₀ is the saturation vapor pressure in the atmosphere. In practice, the equilibrium adsorption of water on the surface is measured at one or (preferably) several discrete partial pressures and the integral is estimated by the area under the curve.

The procedure for measuring the water spreading pressure is detailed in “Dynamic Vapor Sorption Using Water, Standard Operating Procedure”, rev. Feb. 8, 2005 (incorporated in its entirety by reference herein), and is summarized here. Before analysis, 100 mg of the carbon black to be analyzed was dried in an oven at 125° C. for 30 minutes. After ensuring that the incubator in the Surface Measurement Systems DVS1 instrument (supplied by SMS Instruments, Monarch Beach, Calif.) had been stable at 25° C. for 2 hours, sample cups were loaded in both the sample and reference chambers. The target RH was set to 0% for 10 minutes to dry the cups and to establish a stable mass baseline. After discharging static and taring the balance, approximately 10-12 mg of carbon black was added to the cup in the sample chamber. After sealing the sample chamber, the sample was allowed to equilibrate at 0% RH. After equilibration, the initial mass of the sample was recorded. The relative humidity of the nitrogen atmosphere was then increased sequentially to levels of approximately 0, 5, 10, 20, 30, 40, 50, 60, 70, 80, 90, and 95% RH, with the system allowed to equilibrate for 20 minutes at each RH level. The mass of water adsorbed at each humidity level was recorded, from which water spreading pressure was calculated (see above). The measurement was done twice on two separate samples and the average value is reported.

Alternatively or additionally to having the surface energies described herein, in certain embodiments, the carbon black particles have a crystallite size that indicates a relatively high degree of graphitization. A higher degree of graphitization correlates with certain crystalline domains as shown by higher Lₐ crystallite size values, as determined by Raman spectroscopy, where Lₐ is defined as 43.5× (area of G band/area of D band). Raman measurements of Lₐ were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands or peaks at about 1340 cm⁻¹ and 1580 cm⁻¹, denoted as the “D” and “G” bands, respectively. It is generally considered that the D band is attributed to disordered sp² carbon, and the G band to graphitic or “ordered’ sp² carbon. Using an empirical approach, the ratio of the G/D bands and an Lₐ measured by X-ray diffraction (XRD) are highly correlated, and regression analysis gives the empirical relationship:

Lₐ=43.5×(area of G band/area of D band),

in which Lₐ is calculated in Angstroms. Thus, a higher Lₐ value corresponds to a more ordered crystalline structure.

In some embodiments, the carbon black particles have an Lₐ crystallite size of greater than or equal to 50 Å, or less than or equal to 100 A, for example, from 50 Å to 100 Å. The Lₐ crystallite size can have or include, for example, one of the following ranges: from 50 to 90 Å, or from 50 to 80 Å, or from 50 to 70 Å, or from 50 to 60 Å, or from 60 to 100 Å, or from 60 to 90 Å, or from 60 to 80 Å, or from 60 to 70 Å, or from 70 to 100 Å, or from 70 to 90 Å, or from 70 to 80 Å, or from 80 to 100 Å, or from 80 to 90 Å, or from 90 to 100 Å. In certain embodiments, the Lₐ crystallite size is less than or equal to 90 Å, or less than or equal to 80 Å, or less than or equal to 70 Å, or less than or equal to 60 Å. In some embodiments, the Lₐ crystallite size is greater than or equal to 60 Å, or greater than or equal to 70 Å, or greater than or equal to 80 Å, or greater than or equal to 90 Å.

The crystalline domains can be further characterized by an L_{c} crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: L_{c} (Å)=K*λ/(β*cos θ), where K is the shape factor constant (0.9); λ is the wavelength of the characteristic X-ray line of Cu K_{α1} (1.54056 Å); β is the peak width at half maximum in radians; and θ is determined by taking half of the measuring angle peak position (2θ).

A higher L_{c} value corresponds to a more ordered crystalline structure. In some embodiments, the carbon black particles have an L_{c} crystallite size of less than or equal 100 Å, or greater than or equal to 50 Å, for example, from 50 Å to 100 Å. The L_{c} crystallite size can have or include, for example, one of the following ranges: from 50 to 90 Å, or from 50 to 80 Å, or from 50 to 70 Å, or from 50 to 60 Å, or from 60 to 100 Å, or from 60 to 90 Å, or from 60 to 80 Å, or from 60 to 70 Å, or from 70 to 100 Å, or from 70 to 90 Å, or from 70 to 80 Å, or from 80 to 100 Å, or from 80 to 90 Å, or from 90 to 100 Å. In certain embodiments, the L_{c} crystallite size is less than or equal to 90 Å, or less than or equal to 80 Å, or less than or equal to 70 Å, or less than or equal to 60. In some embodiments, the L_{c} crystallite size is greater than or equal to 60 Å, or greater than or equal to 70 Å, or greater than or equal to 80 Å, or greater than or equal to 90 Å.

In various embodiments, the carbon black particles have a high degree of graphitization, as indicated by a high % crystallinity, which is obtained from Raman measurements as a ratio of the area of the G band and the areas of G and D bands (I_{G}/(I_{G}+I_{D})). A high % crystallinity can be achieved by using a high heat treatment temperature and, in some embodiments, a longer heat treatment time (described below). In certain embodiments, the carbon black particles have % crystallinities ((I_{G}/(I_{G}+I_{D}))×100%) ranging from 35% to 70%, as determined by Raman spectroscopy. The % crystallinity ((I_{G}/(I_{G}+I_{D}))×100%) can have or include, for example, one of the following ranges: from 35% to 65%, or from 35% to 60%, or from 35% to 55%, or from 35% to 50%, or from 35% to 45%, or from 35% to 40%, or from 45% to 70%, or from 45% to 65%, or from 45% to 60%, or from 45% to 55%, or from 45% to 50%, or from 55% to 70%, or from 55% to 65%, or from 55% to 60%, or from 60% to 70%, or from 60% to 65%, or from 65% to 70%. The % crystallinity ((I_{G}/(I_{G}+I_{D}))×100%) can have or include, for example, one of the following ranges: greater than 35%, or greater than 40%, or greater than 45%, or greater than 50%, or greater than 55%, or greater than 60%, or greater than 65%, or less than 70%, or less than 65%, or less than 60%, or less than 55%, or less than 50%, or less than 45%, or less than 40%. Raman measurements were made using a Horiba LabRAM Aramis Raman microscope and the accompanying Lab Spec6 software.

Independently of the properties described herein, in some embodiments, the carbon black particles have an aggregate size distribution, as indicated by their D₅₀ values (also known as the “mass median diameter”) of their particle size distributions, that is greater than or equal to 20 nm, or less than or equal to 400 nm, e.g., ranging from 20 nm to 400 nm. Without being bound by theory, it is believed that, for a given structure (e.g., as indicated by an OAN) and mass, a smaller aggregate size is indicative of a higher number of particles, which can improve conductivity. It is believed that carbon black particles having the aggregate size distribution disclosed herein are capable of improving conductivity. The D₅₀ values can have or include, for example, one of the following ranges: from 20 to 350 nm, or from 20 to 300 nm, or from 20 to 250 nm, or from 20 to 200 nm, or from 20 to 150 nm, or from 20 to 100 nm, or from 50 to 400 nm, or from 50 to 350 nm, or from 50 to 300 nm, or from 50 to 250 nm, or from 50 to 200 nm, or from 50 to 150 nm, or from 100 to 400 nm, or from 100 to 350 nm, or from 100 to 300 nm, or from 100 to 250 nm, or from 100 to 200 nm, or from 150 to 400 nm, or from 150 to 350 nm, or from 150 to 300 nm, or from 150 to 250 nm, or from 200 to 400 nm, or from 200 to 350 nm, or from 200 to 300 nm, or from 250 to 400 nm, or from 250 to 350 nm, or from 300 to 400 nm. The D₅₀ values can have or include, for example, one of the following ranges: greater than or equal to 50 nm, or greater than or equal to 100 nm, or greater than or equal to 150 nm, or greater than or equal to 200 nm, or greater than or equal to 250 nm, or greater than or equal to 300 nm, or greater than or equal to 350 nm, or less than or equal to 350 nm, or less than or equal to 300 nm, or less than or equal to 250 nm, or less than or equal to 200 nm, or less than or equal to 150 nm, or less than or equal to 100 nm, or less than or equal to 50 nm. Particle size distribution measurements to determine the D-values disclosed herein were performed using a differential centrifugal sedimentation (DCS) method. The DCS method was performed using a disc centrifuge (CPS Instruments, Model DC24000) and an ultrasonic processor (Branson, Model 450D with a half-inch probe tip). Dispersion samples were prepared by sonicating compositions each containing 0.02 g carbon black and 50 mL dispersion fluid (75% v/v water, 25% v/v ethanol and 0.05%w/v Triton X100 surfactant) at an amplitude of 60% for ten minutes. Instrument settings included a particle density of 1.86; a refractive index of 1.84; an absorptivity of 0.85; and a non-sphericity of 1.0. Run conditions included a disc speed of 24K rpm; a gradient of 24 to 8% sucrose in deionized water (14.4 ml); a gradient density of 1.045; a gradient refractive index of 1.345; a gradient viscosity of 1.25 cP; and a calibration standard of 237 nm polystyrene (density 1.385).

The carbon black particles can have a relatively low oxygen content, which can be indicative of the particles' purity and electrical conductivity properties. In some embodiments, the carbon black has an oxygen content of less than or equal to 0.1 wt %, or less than or equal to 0.06 wt %%, or less than or equal to 0.03 wt %, for example, from 0 to 0.1 wt %. The oxygen content can have or include, for example, one of the following ranges: from 0.01 to 0.1 wt %, or from 0.01 to 0.06 wt %, or from 0.03 to 0.1 wt %, or from 0.03 to 0.06 wt %, or from 0.06 to 0.1 wt %. The oxygen content can be determined by inert gas fusion in which a sample of carbon black particles are exposed to very high temperatures (e.g., about 3000° C.) under inert gas conditions. The oxygen in the sample reacts with carbon to form CO and CO₂, which can be monitored by a non-dispersive infrared technique. The total oxygen content is reported in weight percent relative to the total weight of the sample. Various oxygen analyzers based on the inert gas fusion methods are known in the art and commercially available, for example a LECO® TCH600 analyzer.

In various embodiments, the carbon black particles are heat-treated carbon black particles. “Heat-treated carbon black particles” are carbon black particles that have undergone a “heat treatment,” which as used herein, generally refers to a post-treatment of base carbon black particles that had been previously formed, e.g., by a furnace black process. The heat treatment can occur under inert conditions (i.e., in an atmosphere substantially devoid of oxygen), and typically occurs in a vessel other than that in which the base carbon black particles were formed. Inert conditions include, but are not limited to, a vacuum, and an atmosphere of inert gas, such as nitrogen, argon, and the like. In some embodiments, the heat treatment of carbon black particles under inert conditions is capable of reducing the number of impurities (e.g., residual oil and salts), defects, dislocations, and/or discontinuities in carbon black crystallites and/or increasing the degree of graphitization.

The heat treatment temperatures can vary. In various embodiments, the heat treatment (e.g., under inert conditions) is performed at a temperature of at least 1000° C., or at least 1200° C., or at least 1400° C., or at least 1500° C., or at least 1700° C., or at least 2000° C. In some embodiments, the heat treatment is performed at a temperature ranging from 1000° C. to 2500° C., e.g., from 1400° C. to 1600° C. Heat treatment performed at a temperature refers to one or more temperature ranges disclosed herein, and can involve heating at a steady temperature, or heating while ramping the temperature up or down, either stepwise and/or otherwise.

The heat treatment time periods can vary. In certain embodiments, the heat treatment is performed for at least 15 minutes, e.g., at least 30 minutes, or at least 1 hour, or at least 2 hours, or at least 6 hours, or at least 24 hours, or any of these time periods up to 48 hours, at one or more of the temperature ranges disclosed herein. In some embodiments, the heat treatment is performed for a time period ranging from 15 minutes to at least 24 hours, e.g., from 15 minutes to 6 hours, or from 15 minutes to 4 hours, or from 30 minutes to 6 hours, or from 30 minutes to 4 hours.

Generally, the heat treatment is performed until one or more desired properties of the carbon black particles (e.g., surface energy) are produced. As an example, during initial periods of heat treatment, test samples of heat treated particles can be removed, and their surface energies can be measured. If the measured surface energies are not as desired, then various heat treatment process parameters (such as heat treatment temperature and/or residence time) can be adjusted until the desired surface energy is produced.

The carbon black particles can also be commercially-available particles. Examples of carbon black particles include LITX® 50, LITX® 200, LITX® 300 and LITX® HP carbon black particles available from Cabot Corporation.

“Graphenes” as used herein are carbonaceous material that include at least one single-atom thick sheet of sp²-hybridized carbon atoms bonded to each other to form a honey-comb lattice. Graphenes can include single layer graphenes, few layer graphenes, and/or graphene aggregates. In certain embodiments, the graphenes comprise few-layer graphenes (FLGs) having two or more stacked graphene sheets, e.g., a 2-50 layer graphenes, or 20-50 layer graphenes. In some embodiments, the graphenes include single-layer graphene and/or 2-20 layer graphenes (or other ranges disclosed herein). In other embodiments, the graphenes include 3-15 layer graphenes. The number of layers is estimated from its known relationship to BET surface area of graphene sheets.

The dimensions of graphenes are typically defined by thickness and lateral domain size. Graphene thickness generally depends on the number of layered graphene sheets. The dimension transverse to the thickness is referred to herein as the “lateral” dimension. In various embodiments, the graphenes have a lateral size ranging from 10 nm to 10 μm, e.g., from 10 nm to 5 μm, or from 10 nm to 2 μm, or from 100 nm to 10 μm, or from 100 nm to 5 μm, or from 100 nm to 2 μm, or from 0.5 μm to 10 μm, or from 0.5 μm to 5 μm, or from 0.5 μm to 2 μm, or from 1 μm to 10 μm, or from 1 μm to 5 μm, or from 1 μm to 2 μm.

The graphenes can exist as discrete particles and/or as aggregates. “Aggregates” refers to a plurality of graphene particles (platelets) comprising few layer graphenes that are adhered to each other. For graphene aggregates, “lateral domain size” refers to the longest indivisible dimension of the aggregate. Thickness of the aggregates is defined as the thickness of the individual graphene particle. Graphene aggregates can be generated mechanically, e.g., by exfoliation of graphite.

In some embodiment, the surface area of the graphenes is a function of the number of sheets stacked upon each other and can be calculated based on the number of layers. In certain embodiments, the graphenes have no microporosity. For example, the surface area of a graphene monolayer with no porosity is 2700 m²/g. The surface area of a two-layer graphene with no porosity can be calculated as 1350 m²/g. In other embodiments, the surface area of the graphenes results from the combination of the number of stacked sheets and amorphous cavities or pores. In various embodiments, the graphenes have a microporosity ranging from greater than 0% to 50%, e.g., from 20% to 45% or from 20% to 30%. In some embodiments, the graphenes have a BET surface area greater than or equal to 100 m²/g, or less than or equal to 500 m²/g, for example, ranging from 100 to 500 m²/g. The BET surface area can have or include, for example, one of the following ranges: from 100 to 450 m²/g, or from 100 to 400 m²/g, or from 100 to 350 m²/g, or from 100 to 300 m²/g, or from 100 to 250 m²/g, or from 100 to 200 m²/g, or from 150 to 500 m²/g, or from 150 to 450 m²/g, or from 150 to 400 m²/g, or from 150 to 350 m²/g, or from 150 to 300 m²/g, or from 150 to 250 m²/g, or from 200 to 500 m²/g, or from 200 to 450 m²/g, or from 200 to 400 m²/g, or from 200 to 350 m²/g, or from 200 to 300 m²/g, or from 250 to 500 m²/g, or from 250 to 450 m²/g, or from 250 to 400 m²/g, or from 250 to 350 m²/g, or from 300 to 500 m²/g, or from 300 to 450 m²/g, or from 300 to 400 m²/g, or from 350 to 500 m²/g, or 350 to 450 m²/g, or from 400 to 500 m²/g. The BET surface area can have or include, for example, one of the following ranges: greater than or equal to 150 m²/g, or greater than or equal to 200 m²/g, or greater than or equal to 250 m²/g, or greater than or equal to 300 m²/g, or greater than or equal to 350 m²/g, or greater than or equal to 400 m²/g, or greater than or equal to 450 m²/g, or less than or equal to 450 m²/g, or less than or equal to 400 m²/g, or less than or equal to 350 m²/g, or less than or equal to 300 m²/g, or less than or equal to 250 m²/g, or less than or equal to 200 m²/g, or less than or equal to 150 m²/g. Other ranges within these ranges are possible.

Graphenes can be produced by various methods, including exfoliation of graphite (mechanically, chemically) as well known in the art. Alternatively, graphenes can be synthesized through the reaction of organic precursors such as methane and alcohols, e.g., by gas phase, plasma processes, and other methods known in the art.

Graphenes are described, for example, in U.S. Patent Application Publication 2018-0021499, WO 2017/139115; and U.S. Provisional Patent Application No. 62/566,685. Examples of graphenes include the PAS1001 product from Super C; the LITX® 300G product from Cabot Corporation; HX-GS1 and HX-G8 products from Haoxin; GNC and GNP graphenes available from SUSN; and the xGnP® product from XGSciences.

The carbon black particles and graphenes described herein can be combined with a liquid medium (e.g., a solvent) to form compositions (e.g., slurries, dispersions) that can be used to form electrodes.

The ratio of the carbon black particles to the graphenes particles in the compositions can range from 3:1 to 6:1 by weight. The ratio of the carbon black particles to the graphenes particles can have or include, for example, one of the following ranges, by weight: from 3:1 to 5.5:1; or from 3:1 to 5:1; or from 3:1 to 4.5:1; or from 3:1 to 4:1; or from 3:1 to 3.5:1; or from 3.5:1 to 6:1; or from 3.5:1 to 5.5:1; or from 3.5:1 to 5:1; or from 3.5:1 to 4.5:1; or from 3.5:1 to 4.25:1; or from 3.5:1 to 4:1; or from 3.75:1 to 6:1; or from 3.75:1 to 5.5:1; or from 3.75:1 to 5:1; or from 3.75:1 to 4.5:1; or from 3.75:1 to 4.25:1; or from 4:1 to 6:1; or from 4:1 to 5.5:1; or from 4:1 to 5:1; or from 4:1 to 4.5:1; or from 4.5:1 to 6:1; or from 4.5:1 to 5.5:1; or from 4.5:1 to 5:1; or from 5:1 to 6:1; or from 5:1 to 5.5:1; or from 5.5:1 to 6:1. Other ranges within these ranges are possible.

The liquid medium can be any liquid that is suitable for use with the constituents of the compositions described herein and capable of being used to manufacture the intended electrode. The solvent can be anhydrous, polar and/or aprotic. In some embodiments, the solvent has a high volatility so that, during manufacturing, it can be easily removed (e.g., evaporated), thereby reducing drying time and production costs. Exemplary solvents include, e.g., N-methylpyrrolidone (NMP), acetone, alcohols, and water.

Methods of making the compositions generally include combining the constituents of compositions and forming a homogenous mixture (e.g., by blending). The methods are not particularly limited to any particular order of adding the individual constituents of the compositions or any particular method of mixing. In some embodiments, the compositions further include one or more dispersants (e.g., a cellulosic dispersant), and/or one or more additives (e.g., a maleic anhydride polymer). Examples of dispersants and additives are described in U.S. Provisional Patent Application Nos. 62/680,648 and 62/685,574, and U.S. patent application Ser. No. 16/420,684, all hereby incorporated by reference.

The compositions can be used in the production of a variety of energy storage devices, such as lithium-ion batteries. As an example, the compositions can be used to produce an electrode (e.g., cathode) composition for a lithium-ion battery. The electrode composition typically includes a mixture including the compositions described herein, NCM or NCA, and optionally, a binder.

NCM (also referred to as “NMC”) and NCA are generally known to those skilled in the art of batteries. NCM can be represented by the formula Li₁₊ₓ(Ni_{y}Co_{1-y-z}Mn_{z})₁₋ₓO₂, wherein x ranges from 0 to 1, y ranges from 0 to 1 (e.g., 0.3-0.8), and z ranges from 0 to 1 (e.g., 0.1-0.3). Examples of NCMs include Li₁₊ₓ(Ni_{0.33}Co_{0.33}Mn_{0.33})₁₋ₓO₂, Li₁₊ₓ(Ni_{0.4}Co_{0.3}Mn_{0.3})₁₋ₓO₂, Li₁₊ₓ(Ni_{0.4}Co_{0.2}Mn_{0.4})₁₋ₓO₂, Li₁₊ₓ(Ni_{0.4}Co_{0.1}Mn_{0.5})₁₋ₓO₂, Li₁₊ₓ(Ni_{0.5}Co_{0.1}Mn_{0.4})₁₋ₓO₂, Li₁₊ₓ(Ni_{0.5}Co_{0.3}Mn_{0.2})₁₋ₓO₂, Li₁₊ₓ(Ni_{0.5}Co_{0.1}Mn_{0.3})₁₋ₓO₂, Li₁₊ₓ(Ni_{0.6}Co_{0.2}Mn_{0.2})₁₋ₓO₂, Li₁₊ₓ(Ni_{0.8}Co_{0.1}Mn_{0.1})₁₋ₓO₂ and Li₁₊ₓ(Ni_{0.9}Co_{0.05}Mn_{0.05})₁₋ₓO₂. NCA can be represented by the formula Li₁₊ₓ(Ni_{y}Co_{1-y-z}Al_{z})₁₋ₓO₂, wherein x ranges from 0 to 1, y ranges from 0 to 1, and z ranges from 0 to 1. An example of an NCA is Li₁₊ₓ(Ni_{0.8}Co_{0.15}Al_{0.05})₁₋ₓO₂.

The concentration of NCM or NCA in the electrode composition can vary, depending on the particular type of energy storage device. In some embodiments, the NCM or NCA is present in the electrode composition in an amount of at least 90% by weight, e.g., greater than 95% by weight, relative to the total weight of the electrode composition, e.g., an amount ranging from 90% to 99% by weight, or 95% to 99% by weight, relative to the total weight of the electrode composition.

In other embodiments, the compositions, batteries and methods described herein include other electroactive materials besides NCM and NCA. Exemplary electroactive materials include those selected from at least one of:
LiMPO₄, wherein M represents one or more metals selected from Fe, Mn, Co, and Ni;
LiM′O₂, wherein M′ represents one or more metals selected from Ni, Mn, Co, Al, Mg, Ti, V, Cr, Fe, Zr, Ga, and Si;
Li(M″)₂O₄, wherein M″ represents one or more metals selected from Ni, Mn, Co, Al, Mg, Ti, V, Cr, Fe, Zr, Ga, and Si (e.g., Li[Mn(M″)]₂O₄); and

In certain embodiments, the electroactive material is selected from at least one of LiNiO₂; LiNiₓAl_{y}O₂ where x varies from 0.8-0.99, y varies from 0.01-0.2, and x+y=1; LiCoO₂; LiMn₂O₄; Li₂MnO₃; LiNi_{0.5}Mn_{1.5}O₄; and LiFeₓMn_{y}Co_{z}PO₄ where x varies from 0.01-1, y varies from 0.01-1, z varies from 0.01-0.2, and x+y+z=1.

In other embodiments, the electroactive material is selected from at least one of Li₂MnO₃; LiNi_{1-x-y}MnₓCo_{y}O₂ wherein x ranges from 0.01 to 0.99 and y ranges from 0.01 to 0.99; LiNi_{0.5}Mn_{1.5}O₄; Li₁₊ₓ(Ni_{y}Co_{1-y-z}Mn_{z})₁₋ₓO₂, wherein x ranges from 0 to 1, y ranges from 0 to 1 and z ranges from 0 to 1; and layer-layer compositions containing at least one of an Li₂MnO₃ phase and an LiMn₂O₃ phase.

In some embodiments, the electrode includes a mixture of active materials having a nickel-doped Mn spinel, and a layer-layer Mn rich composition. The nickel-doped Mn spinel can have the formula LiNi_{0.5}Mn_{1.5}O₄, and the layer-layer Mn rich composition can contain a Li₂MnO₃ or a LiMn₂O₃ phase, and mixtures thereof.

The total concentration of the graphenes and the carbon black particles in the electrode composition can range from 0.1 to 2 wt %. The total concentration of the graphenes and the carbon black particles in the composition can have or include, for example, one of the following ranges: from 0.1 to 1.75 wt %; or from 0.1 to 1.5 wt %; or from 0.1 to 1.25 wt %; or from 0.1 to 1 wt %; or from 0.1 to 0.75 wt %; or from 0.5 to 2 wt %; or from 0.5 to 1.75 wt %; or from 0.5 to 1.5 wt %; or from 0.5 to 1.25 wt %; or from 0.5 to 1 wt %; or from 0.5 to 0.75 wt %; or from 1 to 2 wt %; or from 1 to 1.75 wt %; or from 1 to 1.5 wt %; or from 1 to 1.25 wt. Other ranges within these ranges are possible.

In certain embodiments, the carbon black particles in the electrode composition can be present in the range of 0.1 to 1.75 wt % relative to the total weight of the electrode composition. The carbon black particles in the electrode composition can have or include, for example, one of the following ranges: from 0.1 to 1.5 wt %, or from 0.1 to 1.25 wt %, or from 0.1 to 1 wt %, from 0.1 to 0.75 wt %, or from 0.1 to 0.5 wt %, or from 0.5 to 1.75 wt %, or from 0.5 to 1.5 wt %, or from 0.5 to 1.25 wt %, or from 0.5 to 1 wt %, or from 0.5 to 0.75 wt %, or from 0.75 to 1.75 wt %, or from 0.75 to 1.5 wt %, or from 0.75 to 1.25 wt %, or from 0.75 to 1 wt %, or from 1 to 1.75 wt %, or from 1 to 1.5 wt %, or from 1 to 1.25 wt %, or from 1.25 to 1.75 wt %, or from 1.25 to 1.5 wt %, or from 1.5 to 1.75 wt %. Other ranges within these ranges are possible.

In certain embodiments, the graphenes particles in the electrode composition can be present in the range of 0.1 to 0.5 wt % relative to the total weight of the electrode composition. The carbon black particles in the electrode composition can have or include, for example, one of the following ranges: from 0.1 to 0.25 wt %, or from 0.25 to 0.5 wt %. Other ranges within these ranges are possible.

The ratio of the carbon black particles to graphenes particles in the electrode composition can range from 3:1 to 6:1, as described above for the compositions used to make the electrode compositions.

In certain embodiments, the electrode composition further includes one or more binders to enhance the mechanical properties of the formed electrode. Exemplary binder materials include, but are not limited to, fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. Other possible binders include polyethylene, polypropylene, ethylene-propylene-diene terpolymer (EPDM), sulfonated EPDM, styrene-butadiene rubber (SBR), and fluoro rubber and copolymers and mixtures thereof. In some embodiments, the binder is present in the cathode composition in an amount of 1 to 10% by weight.

An electrode (e.g., cathode) composition can be made by homogeneously interspersing (e.g., by uniformly mixing) the compositions described herein with the NCM or NCA. In some embodiments, the binder is also homogeneously interspersed with the compositions described herein and NCM or NCA. The electrode composition can take the form of a paste or a slurry, in which particulate NCM or NCA, conductive additives, dispersant(s) (if present), other additive(s) (if present), solvent, and binder (if present) are combined. The constituents of the electrode composition can be combined in any order so long as the resulting mixture is substantially homogeneous, which can be achieved by shaking, stirring, etc. In certain embodiments, the electrode composition is a solid resulting from solvent removal from the paste or slurry.

In some embodiments, an electrode is formed by depositing the paste onto an electrically conducting substrate (e.g., an aluminum current collector), followed by removing the solvent. In certain embodiments, the paste has a sufficiently high solids loading (i.e., high concentration of solids) to enable deposition onto the substrate while minimizing the formation of inherent defects (e.g., cracking) that may result with a less viscous paste (e.g., having a lower solids loading). Moreover, a higher solids loading reduces the amount of solvent needed. The solvent is removed by drying the paste, either at ambient temperature or under low heat conditions, e.g., temperatures ranging from 20° to 120° C. The deposited electrode/current collector can be cut to the desired dimensions, optionally followed by calendering.

The formed electrode can be incorporated into a lithium-ion battery according to methods known in the art, for example, as described in “Lithium Ion Batteries Fundamentals and Applications,” by Yuping Wu, CRC press, (2015).

In other embodiments, the compositions described herein are used (e.g., incorporated) in electrodes of other energy storage devices, such as, primary alkaline batteries, primary lithium batteries, nickel metal hydride batteries, sodium batteries, lithium sulfur batteries, lithium air batteries, and supercapacitors. Methods of making such devices are known in the art and are described, for example, in “Battery Reference Book”, by TR Crompton, Newness (2000).

### EXAMPLES

### Example 1

Seven NCM cathode formulations (Table 1) were made following a three-step mixing protocol with a Thinky ARE310 planetary centrifugal mixer. The first step included 12 minutes of active mixing of a carbon black (CB)/PVDF/NMP millbase; the second step included adding CNT and NMP, as needed, and mixing for 12 more minutes; and the third step included adding active material (NCM622 from Sanshan) and mixing for 12 more minutes. The millbase was mixed with two small milling tungsten carbide media during the first and second steps and without media in the third step. The NCM electrode slurry was coated on 20 micron-thick aluminum foil at an area loading of 25 mg/cm² and dried at 110° C. in a convection oven to remove the NMP solvent. In Table 1, CNTs indicates a 1:1 blend of LB107+LB101 carbon nanotubes from Cnano Technology Ltd. LITX® HP and LITX® G300 carbons are available from Cabot Corporation. Ketjenblack® EC-300 acetylene black is available from AkzoNobel. The loading of the electrodes was 25 or 30 mg/cm² and density was 3.5 g/cc. The binder was 1.5% PVDF (Arkema HSV900) in formulations 1-6, and 2% Kurhea KF7200 in formulation 7. The physico-chemical characteristics of components used in formulations #1-7 are listed in Table 2.

TABLE 1
Experimental Design

| | Type 1 | Type 1 | Type 2 | Type 2 | Type 3 | Type 3 | Electrode |
|---|---|---|---|---|---|---|---|
| | conductive | conductive | conductive | conductive | conductive | conductive | loading |
| No. | additive | content | additive | content | additive | content | [mg/cm²] |
| 1 | LITX ® HP | 1.21% | LITX ® G300 | 0.29% | | | 25, 30 |
| 2 | LITX ® HP | 0.84% | Ketjenblack ® EC-300 | 0.44% | CNTs | 0.21% | 30 |
| 3 | LITX ® HP | 1.21% | Ketjenblack ® EC-300 | 0.18% | CNTs | 0.28% | 30 |
| 4 | LITX ® HP | 1.5% | | | | | 25, 30 |
| 5 | LITX ® HP | 1.28% | LITX ® G300 | 0.22% | | | 25, 30 |
| 6 | LITX ® HP | 1.39% | Ketjenblack ® EC-300 | 0.11% | | | 25, 30 |
| 7 | LITX ® HP | 0.8% | | | CNTs | 1.2% | 25 |

TABLE 2
Physico-chemical characteristics of carbons used in formulations

| | | BET | STSA | OAN |
|---|---|---|---|---|
| Identification | Carbon Form | (m²/g) | (m²/g) | (ml/100 g) |
| LITX ® HP | Carbon black | 100 | 100 | 245 |
| Ketjenblack ® | Acetylene black | 853 | 553 | 370 |
| EC-300 | | | | |
| LITX ® 300G | Graphene | 300 | N/A | 115 |

### Example 2

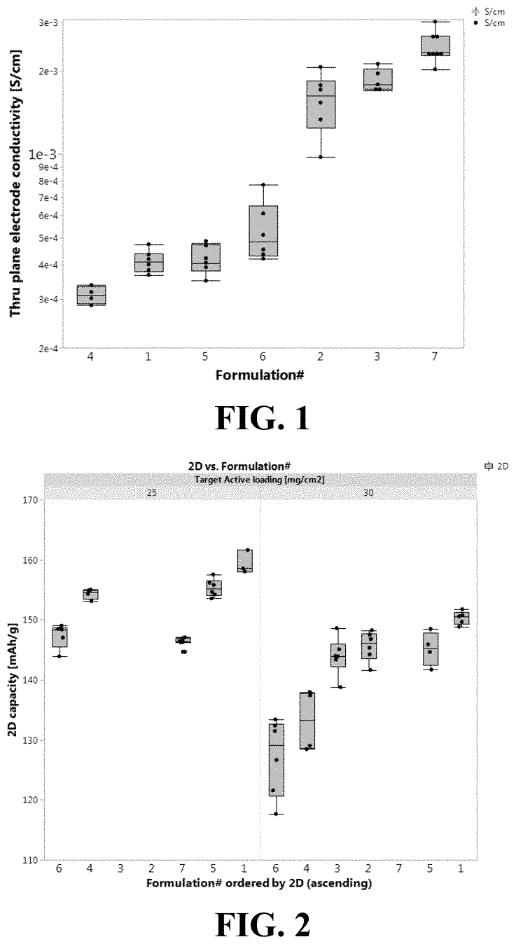

A custom-made through-plane conductivity fixture was used for conductivity measurements and test results are shown in FIG. 1. Through-plane conductivity was measured on electrodes calendered at 3.5 g/cc. Only formulations #2, 3 and 7 containing CNTs had conductivity >1 mS/cm, and formulation #7 with the highest content of CNTs had the highest conductivity. Also, formulations #1, 5 and 6 had higher conductivity than formulation #4 (1.5% LITX® HP carbon only).

### Example 3

Electrodes were dried overnight at 110° C. under vacuum, then five 2032-half-coin-cells were assembled in an argon-filled glove-box for each formulation. Whatman fiberglass was used as a separator, lithium foil was used as a counter electrode, and EC-DMC-EMC, VC, LiPF6 1v-1v-1v,1%, 1M was used as an electrolyte. The coin-cells were tested with a Maccor Series 4000 battery cycler in a range of 4.3-2.8V for discharge rate capability (0.5C and 0.1, 0.2, 0.5, 1, 2, 3, 4, and 5D rates), fast charge rate capability (0.5D and 0.5, 1, 1.5, 2, 2.5, and 3C rates) and Hybrid Pulse Power Capability (10 s 1.5C, 2D pulses at 80, 50 and 20% states-of-charge).

In both electrode loadings tested (25 and 30 mg/cm²), the highest 2D capacity was achieved with formulation #1, that is 1.21% LITX® HP carbon +0.29% LITX® G300 graphenes. Notably, this formulation outperformed 1.5% LITX® HP carbon alone, and a blend of LITX® HP carbon and CNTs with a higher total CCA of 2 wt. % (formulation #7) even though the electronic conductivity of the blend was higher (FIG. 2).

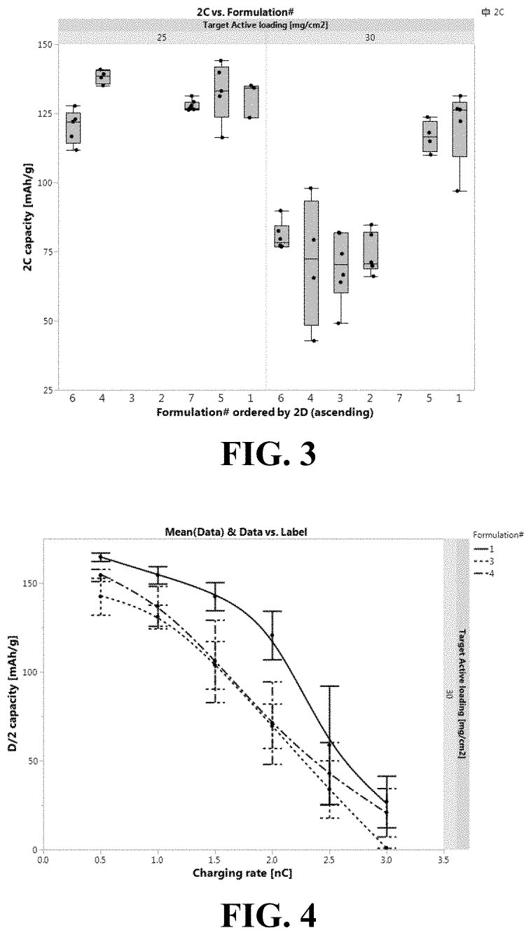

Furthermore, the fast charging capability of the cathodes was notably higher with formulations #1 and 5 containing graphenes, especially in the case of 30 mg/cm² loading, as illustrated in FIG. 3.

Finally, a comparison of formulations #1, 3 and 4 over the whole range of charging rates clearly illustrates the benefit observed when replacing 0.21% carbon black with graphenes, while a ternary blend of carbon black, acetylene black and CNTs does not provide such benefit.

### Example 4

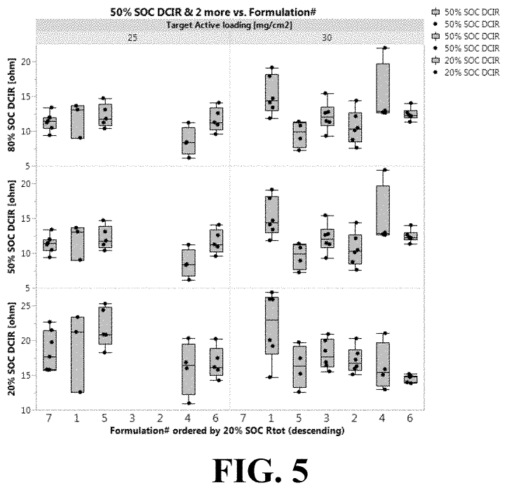

It is also important to note that the DC-IR of the cells showed no strong differentiation amongst formulations, and overall less variability in formulation #6 of only carbon black and acetylene black (FIG. 5). It was found that a small (0.2-0.3%) amount of graphene (e.g., LITX® G300 graphenes) added to carbon black (e.g., LITX® HP carbon) could outperform similar formulations of only LITX® HP additive or LITX® HP additive blended with CNTs in fast charge and fast discharge tests. This can provide a performance boost to advanced carbon (e.g., LITX® HP carbon), at a cost significantly lower than CNTs.

The use of the terms “a” and “an” and “the” is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All publications, applications, ASTM standards, and patents referred to herein are incorporated by reference in their entirety.

Still other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof

What is claimed is:

1. An electrode, comprising:
an electrode composition comprising
graphenes;
carbon black particles having a Brunauer-Emmett-Teller (BET) surface area greater than 90 m²/g, and an oil adsorption number (OAN) greater than 150 mL/100 g, wherein the ratio of the carbon black particles to the graphenes ranges from 3:1 to 6:1 by weight; and
an electroactive material selected from the group consisting of lithium nickel cobalt manganese oxide and lithium nickel cobalt aluminum oxide,
wherein the total concentration of the graphenes and the carbon black particles is equal to or less than 2 wt % of the electrode composition; and
a current collector contacting the electrode composition.

2. The electrode of claim 1, wherein the total concentration of the graphenes and the carbon black particles ranges from 0.1 to 2 wt % of the electrode composition.

3. The electrode of claim 1, wherein the ratio of the carbon black particles to the graphenes ranges from 3.5:1 to 4.5:1 by weight.

4. The electrode of claim 1, comprising from 95 to 99 wt % of the electroactive material.

5. The electrode of claim 1, the electroactive material comprises lithium nickel cobalt manganese oxide.

6. The electrode of claim 1, wherein the carbon black particles have a BET surface area less than 400 m²/g.

7. The electrode of claim 1, wherein the carbon black particles have an OAN less than 250 mL/100 g.

8. The electrode of claim 1, wherein the carbon black particles have a surface energy less than 5 mJ/m².

9. The electrode of claim 1, wherein the carbon black particles have an Lₐ crystallite size, as determined by Raman spectroscopy, ranging from 50 Å to 100 Å.

10. The electrode of claim 1, wherein the carbon black particles have an L_{c} crystallite size, as determined by X-ray diffraction, ranging from 50 Å to 100 Å.

11. The electrode of claim 1, wherein the carbon black particles have a % crystallinity ((I_{G}/(I_{G}+I_{D}))×100%), as determined by Raman spectroscopy, ranging from 35% to 70%.

12. The electrode of claim 1, wherein the carbon black particles have an aggregate size distribution, as indicated by D₅₀ values of particle size distributions, ranging from 20 to 400 nm.

13. The electrode of claim 1, wherein the carbon black particles have one, two, three, four, five, six, or seven of the following properties, in any combination:
(a) a surface energy less than 5 mJ/m²;
(b) an Lₐ crystallite size, as determined by Raman spectroscopy, greater than 50 Å;
(c) an L_{c} crystallite size, as determined by X-ray diffraction, greater than 50 Å;
(d) % crystallinity ((I_{G}/(I_{G}+I_{D}))×100%), as determined by Raman spectroscopy, greater than 35%;
(e) an STSA greater than 50 m²/g;
(f) an aggregate size distribution, as indicated by D₅₀ values of particle size distributions, greater than 20 nm; and/or
(g) an oxygen content from 0 to 0.1 wt %.

14. The electrode of claim 1, wherein the carbon black particles have one, two, three, four, five, or six of the following properties, in any combination:
(a) an Lₐ crystallite size, as determined by Raman spectroscopy, less than 100 Å;
(b) an L_{c} crystallite size, as determined by X-ray diffraction, less than 100 Å;
(c) % crystallinity ((I_{G}/(I_{G}+I_{D}))×100%), as determined by Raman spectroscopy, less than 70%;
(d) an STSA less than 250 m²/g;
(e) an aggregate size distribution, as indicated by D₅₀ values of particle size distributions, less than 400 nm; and/or
(f) an oxygen content from 0 to 0.1 wt %.

15. The electrode of claim 1, wherein the carbon black particles have one, two, three, four, five, or six of the following properties, in any combination:
(a) an Lₐ crystallite size, as determined by Raman spectroscopy, ranging from 50 Å to 100 Å;
(b) an L_{c} crystallite size, as determined by X-ray diffraction, ranging from 50 Å to 100 Å;
(c) a % crystallinity ((I_{G}/(I_{G}+I_{D}))×100%), as determined by Raman spectroscopy, ranging from 35% to 70%;
(d) an STSA ranging from 50 to 250 m²/g;
(e) an aggregate size distribution, as indicated by D₅₀ values of particle size distributions, ranging from 20 to 400 rim; and/or
(f) oxygen content from 0 to 0.1 wt %.

16. The electrode of claim 1, wherein the graphenes have one or both of the following properties:
(a) a BET surface area greater than 100 m²/g; and/or
(b) less than or equal to about 20 graphitic layers.

17. The electrode of claim 1, wherein the graphenes have one or both of the following properties:
(a) a BET surface area less than 500 m²/g; and/or
(b) more than or equal to about 5-graphitic layers.

18. The electrode of claim 1, wherein the graphenes have one or both of the following properties:
(a) a BET surface area ranging from 100 to 500 m²/g; and/or
(b) from about 20 to about 5 graphitic layers.

19. A battery comprising an electrode of claim 1.

20. A composition, comprising:
graphenes;
carbon black particles having a Brunauer-Emmett-Teller (BET) surface area greater than 90 m²/g, and an oil adsorption number (OAN) greater than 150 mL/100 g, wherein the ratio of the carbon black particles to the graphenes ranges from 3:1 to 6:1 by weight; and
a liquid medium.

21-40. (canceled)
